(19) United States
(12) Patent Application Publication
(10) Pub. No.: US 2010/0316808 A1
(43) Pub. Date: Dec. 16, 2010

(54) Polyolefin Compositions for Coating Applications

(76) Inventors: Gregory Keith Hall, Humble, TX (US); James N. Coffey, League City, TX (US); John Michael Donahue, Greenville, SC (US)

Correspondence Address: EXXONMOBIL CHEMICAL COMPANY, 5200 BAYWAY DRIVE, P.O. BOX 2149, BAYTOWN, TX, 77522-2149, US

(21) Appl. No.: 12/772,811

(22) Filed: May 3, 2010

Related U.S. Application Data
(60) Provisional application No. 61/187,431, filed on Jun. 16, 2009.

(51) Int. Cl. B05D 3/00

(52) U.S. Cl. 427/398.1

(57) ABSTRACT

A method for coating articles by melting and applying a composition to at least a portion of the article to be coated and then cooling the composition to form a coated article wherein the composition comprises a propylene-based polymer having a weight molecular weight of about 10,000 to about 100,000; a percent crystallinity of about 5% to about 40%; and a melt index of about 30 dg/min or more.

### CROSS REFERENCE TO RELATED APPLICATIONS

This application claims the benefit of prior U.S. provisional application Ser. No. 61/187,431 filed Jun. 16, 2009, which is hereby incorporated by reference in its entirety.

### BACKGROUND

1. Field of the Invention

Embodiments of the present invention generally relate to method of forming a coated article with a polyolefin composition.

2. Description of the Related Art

Coating compositions have been made using polymer compositions that have similar properties to adhesives. A common adhesive for coating compositions is the hot-melt adhesive, which is a material that can be heated to a melt and then applied to various substrates such that a bond is formed upon cooling. Common hot melt adhesives formulations include thermoplastic polymers, particularly ethylene-based polymers such as ethylene-vinyl acetate copolymers (“EVA”), and other alpha-olefin copolymers derived predominantly from ethylene (see, for example, International Patent Publication Nos. WO98/03603 and WO99/24516).

Copolymers derived predominantly from propylene have also been proposed for use in adhesive compositions. For example, U.S. Pat. No. 3,954,697 discloses a single component, hot-melt, pressure-sensitive adhesive based on propylene/higher 1-olefin copolymers containing 40-60 mole % of the higher 1-olefin that are produced using a Ziegler-Natta catalyst. Suitable comonomers include 1-hexene, 1-heptene, 1-octene, 1-nonene and 1-decene. The copolymer has a melt viscosity range at 190° C. of 10,000 cp to 75,000 cp, a density of 0.85 to 0.86 g/cm³, a glass transition temperature of −30° C. to −45° C., and has no melting point measurable by Differential Scanning Calorimetry (DSC). Thus, the copolymer is amorphous with no residual crystallinity or crystallinity of a very low order.

U.S. Pat. No. 6,747,114 discloses an adhesive composition comprising a semi-crystalline copolymer of propylene and at least one comonomer selected from ethylene and C₄ to C₂₀ α-olefins having a propylene content of greater than 65 mole percent; wherein the copolymer has a weight average molecular weight (Mw) from about 15,000 to about 200,000; a melt index (MI) from about 7 dg/min to about 3000 dg/min as measured by ASTM D 1238(B); and a weight average molecular weight/number average molecular weight ratio (Mw/Mn) of approximately 2. In Example 4, propylene is copolymerized with between 11 and 19 wt % 1-hexene at a temperature of 76° C. to 90° C. over a catalyst comprising dimethylsilandiylbis(2-methyl-4-phenyl-1-indenyl)zirconium dimethyl activated with dimethylanilinium-tetrakis (pentafluorophenyl) borate to produce semi-crystalline copolymers having a melting temperature, Tₘ, between 93° C. and 107° C., a heat of fusion, ΔH, between 58.5 and 96.6 J/g and a melt viscosity at 190° C. of between 2230 and 66,000 cps. Pressure sensitive hot melt adhesives are formed by blending 30 wt % of each copolymer with 50 wt % of Escorez® 5380 tackifier and 20 wt % of Kaydol Oil and the resulting adhesives exhibit a tensile strength in excess of 127 psi, an elongation in excess of 368% and a Shear Adhesion Failure Temperature (SAFT) to Kraft paper of 74° C. to 83° C. In addition, for the copolymer formed from 19 wt % 1-hexene, a hot melt adhesive is formed by blending 80 wt % of the copolymer with 15 wt % of Escorez® 5380 tackifier and 5 wt % of Kaydol Oil. The resulting adhesive exhibits a tensile strength of 1452 psi, an elongation of 768% and a Shear Adhesion Failure Temperature (SAFT) to Kraft paper of 102.5° C. All of the adhesives formed had at least 20% of the other ingredients due to the high molecular weight of the starting copolymers, and had a long set time.

International Patent Publication No. WO 2004/046214, published Jun. 3, 2004, discloses a polyolefin adhesive comprising a polymer having a Dot T-Peel of 1 N or more on Kraft paper, an Mw of 10,000 to 100,000, a branching index (g′) of 0.95 or less measured at the Mz of the polymer and a heat of fusion of 1 to 70 J/g, wherein the polymer comprises 50 wt % or more of an alpha-olefin having 3 to 30 carbon atoms, and optionally up to 50 wt % of a comonomer selected from the group consisting of ethylene, butene, hexene, octene, decene, dodecene, pentene, heptene, nonene, 4-methyl-pentene-1,3-methyl pentene-1,3,5,5-trimethyl-hexene-1, and 5-ethyl-1-nonene, and up to 10 wt % of a diene. The polymer is preferably produced using a mixed catalyst system comprising a first transition metal compound capable of producing a crystalline poly-alpha-olefin, preferably isotactic or syndiotactic polypropylene, having a crystallinity of 20% or more, and a second transition metal compound capable of producing an amorphous poly-alpha-olefin, preferably atactic polypropylene, having a crystallinity of 5% or less.

There is a need, therefore, for coating compositions using low molecular weight polymers having low viscosity and a low melting point having excellent adhesion at low and high temperatures in combination with excellent mechanical strength.

### SUMMARY

A method for forming a coated article is provided such method comprising the steps of:

(i) melting a composition comprising at least one polymer comprising 50 wt % propylene derived units, the polymer having:
a weight average molecular weight (Mw) of about 10,000 to about 100,000;
a percent crystallinity of about 5% to about 40%;
a melt index of about 30 dg/min or more; and
a melting point of about 40° C. to about 150° C.,

(ii) applying the melted composition to at least a portion of the article to be coated to form a coating having a first side adhering to the article and a second side substantially free of an additional substrate in which to adhere; and

(iii) cooling the article to form a coated article.

### DETAILED DESCRIPTION

A detailed description will now be provided. Each of the appended claims defines a separate invention, which for infringement purposes is recognized as including equivalents to the various elements or limitations specified in the claims. Depending on the context, all references below to the “invention” may in some cases refer to certain specific embodiments only. In other cases it will be recognized that references to the “invention” will refer to subject matter recited in one or more, but not necessarily all, of the claims. Each of the inventions will now be described in greater detail below, including specific embodiments, versions and examples, but the inventions are not limited to these embodiments, versions or examples, which are included to enable a person having ordinary skill in the art to make and use the inventions, when the information in this patent is combined with available information and technology.

The adhesive compositions of the invention are composed of polyolefin polymer compositions, which include propylene polymers. Propylene-based polymers are polymers comprised of a majority of propylene monomers on a molar basis. As used herein, “polypropylene”, “polypropylene polymer(s)”, or “propylene polymer(s)” mean (i) homopolymers, copolymers, terpolymers, higher order copolymers, or interpolymers comprised of a majority of propylene monomers on a molar basis or (ii) combinations thereof.

As used herein, the term “homopolymer” means polymers resulting from the polymerization of a single monomer, i.e., a polymer consisting essentially of a single type of repeating unit.

The coating composition described herein comprises at least one polymer. Preferably, the coating composition comprises at least about 50 wt %, about 60 wt %, about 70 wt %, about 80 wt %, and about 90 wt % of the at least one polymer. The polymer can be a propylene homopolymer or a propylene copolymer having at least 50 wt % propylene derived units and one or more other olefins. For example, the propylene polymer can contain about 58 wt %, about 60 wt %, about 65 wt %, about 70 wt %, about 75 wt %, about 80 wt %, about 85 wt %, about 90 wt %, about 92 wt %, about 94 wt %, about 95 wt %, about 96 wt %, about 97 wt %, about 98 wt %, or about 99 wt % of propylene derived units with the balance being ethylene or one or more C₄ to C₁₀ alpha-olefins. In one or more embodiments, the propylene polymer can include about 1 wt % to about 30 wt %, about 2 wt % to about 30 wt %, about 2 wt % to about 15 wt %, about 2 wt % to about 12 wt %, about 2 wt % to about 10 wt %, about 5 wt % to about 15 wt %, about 5 wt % to about 12 wt %, or about 5 wt % to about 12 wt % of units derived from ethylene or at least one C₄ to C₁₀ alpha-olefin. In a preferred embodiment, the propylene polymer contains about 85 wt % to about 95 wt % of propylene-derived units and about 5 wt % to about 15 wt % of units derived from ethylene or at least one C₄ to C₁₀ alpha-olefin. In one or more embodiments above or elsewhere herein, the propylene polymer is a copolymer of propylene and hexene.

### Molecular Weight Distribution (MWD)

The ratio (“MWD”) of the weight averaged molecular weight (Mw) of the propylene polymer to the number averaged molecular weight (Mn) of the propylene polymer can be of from about 1.8 to about 9.0. The MWD can be from about 2.0 to about 9.0. The MWD can be from about 2.0 to about 5.0. In one or more embodiments, the MWD of the propylene polymer can range from a low about 1.8, 2.4, or 3.0 to a high of about 4.0, 5.5, or 8.5. The MWD of the propylene polymer can also range from a low about 1.8, 2.6, or 3.2 to a high of about 5.3, 7.5, or 8.8.

Molecular weight distribution (MWD) is a measure of the range of molecular weights within a given polymer sample. It is well known that the breadth of the MWD can be characterized by the ratios of various molecular weight averages, such as the ratio of the weight average molecular weight to the number average molecular weight, Mw/Mn, or the ratio of the Z-average molecular weight to the weight average molecular weight, Mz/Mw.

Mz, Mw and Mn can be measured using gel permeation chromatography (GPC), also known as size exclusion chromatography (SEC). This technique utilizes an instrument containing columns packed with porous beads, an elution solvent, and detector in order to separate polymer molecules of different sizes. In a typical measurement, the GPC instrument used is a Waters chromatograph equipped with ultrastyro gel columns operated at 145° C. The elution solvent used is trichlorobenzene. The columns are calibrated using sixteen polystyrene standards of precisely known molecular weights. A correlation of polystyrene retention volume obtained from the standards to the retention volume of the polymer tested yields the polymer molecular weight.

Average molecular weights M can be computed from the expression:

$$M = \frac{{\sum }_{i} {N}_{i} {M}_{i}^{n + 1}}{{\sum }_{i} {N}_{i} {M}_{i}^{n}}$$

where Nᵢ is the number of molecules having a molecular weight K. When n=0, M is the number average molecular weight (Mn). When n=1, M is the weight average molecular weight (Mw). When n=2, M is the Z-average molecular weight (Mz). The desired MWD function (e.g., Mw/Mn or Mz/Mw) is the ratio of the corresponding M values. Measurement of M and MWD is well known in the art and is discussed in more detail in, for example, Slade, P. E. Ed., Polymer Molecular Weights Part II, Marcel Dekker, Inc., NY, (1975) 287-368; Rodriguez, F., Principles of Polymer Systems 3rd ed., Hemisphere Pub. Corp., NY, (1989) 155-160; U.S. Pat. No. 4,540,753; Verstrate et al., Macromolecules, vol. 21, (1988) 3360; and references cited therein.

Weight Averaged Molecular Weight (Mw)

The propylene polymer can have a weight averaged molecular weight (Mw) that is less than 100,000. Preferably, the Mw of the propylene polymer is less than 90,000, 80,000, 75,000, 70,000, 65,000, 60,000, 55,000, 50,000, 40,000, 30,000, 20,000 or 15,000, and at least 10,000, 12,000, 15,000, 20,000, 25,000, 35,000, 45,000, 55,000, 65,000, 75,000, or 85,000. In one or more embodiments, the Mw of the polymer ranges from a low about 5,000, about 10,000, or about 15,000 to a high of about 60,000, about 80,000, or about 100,000. In one or more embodiments, the Mw of the propylene polymer ranges from a low about 10,000, about 16,000, or about 22,000 to a high of about 66,000, about 78,000, or about 98,000.

### Melting Point (Tm), Heat of Fusion (Hf), and Percent Crystallinity

The propylene polymer can have a melting point (Tm) of about 40° C. to about 150° C. The melting point of the propylene polymer can range from about 60° C. to about 140° C.; about 60° C. to about 110° C.; about 80° C. to about 140° C.; about 85° C. to about 125° C.; or about 90° C. to about 120° C.; or about 95° C. to about 110° C. The melting point of the propylene polymer can further range from a low of about 40° C., 60° C., or 70° C. to high of about 100° C., 110° C., or 120° C. The melting point of the propylene polymer can also range from a low of about 85° C., 95° C., or 100° C. to high of about 105° C., 115° C., or 130° C.

The propylene polymer can have a heat of fusion as determined by differential scanning calorimetry (DSC) between about 10 J/g and about 80 J/g. For example, the heat of fusion of the propylene polymer can range from about 10 J/g to about 75 J/g; about 10 J/g to about 60 J/g; or about 20 J/g to about 50 J/g; or about 20 J/g to about 40 J/g. The heat of fusion can further range from a low about 10 J/g, 15 J/g or 20 J/g to a high of about 35 J/g, 45 J/g or 55 J/g.

The propylene polymer can have a percent crystallinity of about 5% to about 40%. For example, the percent crystallinity of the propylene polymer can range from about 6% to about 35%; or about 10% to about 30%; or about 15% to about 25%. The percent crystallinity can further range from a low about 5%, 10% or 15% to a high of about 20%, 30% or 40%. The percent crystallinity can further range from a low about 10%, 15% or 20% to a high of about 25%, 35% or 40%.

Melting point (Tm), crystallization temperature (Tc), heat of fusion (Hf), and percent crystallinity can be determined by differential scanning calorimetry (DSC) by the following procedure according to ASTM E 794-85 using a TA Instruments model 2910 machine or a Perkin-Elmer DSC 7 machine. Prior to the DSC measurement, the samples are aged (typically by holding at ambient temperature for a period up to about 2 days) or annealed to maximize the level of crystallinity. Samples weighing approximately 5-10 mg are sealed in aluminum sample pans. The DSC data are recorded by first cooling the sample to −50° C. and then gradually heating it to 200° C. at a rate of 10° C./minute. The sample is kept at 200° C. for 5 minutes before a second cooling-heating cycle is applied. Both the first and second cycle thermal events are recorded. Areas under the melting curves are measured and used to determine the heat of fusion and the degree of crystallinity. The percent crystallinity (X %) is calculated using the formula, X %=[area under the curve (Joules/gram)/B (Joules/gram)]*100, where B is the heat of fusion for the homopolymer of the major monomer component. These values for B are to be obtained from the Polymer Handbook, Fourth Edition, published by John Wiley and Sons, New York 1999. A value of 189 J/g (B) is used as the heat of fusion for 100% crystalline polypropylene. The melting temperature is measured and reported during the second heating cycle (or second melt). Typically, a sample of the polymer will show secondary melting peaks adjacent to the principal peak, which peaks are considered together as a single melting point. The highest of these peaks is considered the melting point.

### Melt Index

The propylene polymer can have a melt index (I₂) of 25 dg/min or more, 30 dg/min or more, 50 dg/min or more, 100 dg/min or more, 200 dg/min or more, 500 dg/min or more, or 2,000 dg/min or more, as measured by ASTM D 1238(B) at 2.16 kg, 190° C. In one or more embodiments, the propylene polymer can have a melt index about 2,000 dg/min to about 15,000 dg/min; about 2,000 dg/min to about 10,000 dg/min; or about 3,000 dg/min to about 8,000 dg/min.

### Branching Index

The propylene polymer can have a branching index (g′) of 0.95 or less measured at the Mz of the propylene polymer when the polymer has an Mw of 10,000 to 100,000. The propylene polymer can also have a branching index (g′) of 0.98 or less measured at the Mz of the propylene polymer when the propylene polymer has an Mw of 10,000 to 60,000.

The branching index (g′) can be measured using SEC with an on-line viscometer (SEC-VIS) and is reported as g′ at each molecular weight in the SEC trace. The branching index g′ is defined as:

$${g}^{'} = \frac{{η}_{b}}{{η}_{l}}$$

where η_{b} is the intrinsic viscosity of the branched polymer and η₁ is the intrinsic viscosity of a linear polymer of the same viscosity-averaged molecular weight (Mᵥ) as the branched polymer. η₁=KM_{V}^{α}, K and α are measured values for linear polymers and should be obtained on the same SEC-DRI-LS-VIS instrument as the one used for branching index measurement. For example, K=0.0002288 and α=0.705 can be used for polypropylene homopolymers. The SEC-DRI-LS-VIS method obviates the need to correct for polydispersities, since the intrinsic viscosity and the molecular weight are measured at individual elution volumes, which arguably contain narrowly dispersed polymer. Linear polymers selected as standards for comparison should be of the same viscosity average molecular weight, monomer content and composition distribution. Linear character for polymer containing C₂ to C₁₀ monomers is confirmed by Carbon-13 NMR using the method of Randall (Rev. Macromol. Chem. Phys., C29 (2&3), p. 285-297). Linear character for C₁₁ and above monomers is confirmed by GPC analysis using a MALLS detector. For example, for a copolymer of propylene, the NMR should not indicate branching greater than that of the co-monomer (i.e. if the comonomer is butene, branches of greater than two carbons should not be present). For a homopolymer of propylene, the GPC should not show branches of more than one carbon atom. When a linear standard is desired for a polymer where the comonomer is C9 or more, one can refer to T. Sun, P. Brant, R. R. Chance, and W. W. Graessley, Macromolecules, Volume 34, Number 19, 6812-6820, (2001) for protocols on determining standards for those polymers. In the case of syndiotactic polymers, the standard should have a comparable amount of syndiotacticity as measured by Carbon 13 NMR. The viscosity averaged g′ was calculated using the following equation:

$${g}_{vis}^{'} = \frac{\sum {{C}_{i} [ {η}_{i} ]}_{b}}{\sum {C}_{i} {KM}_{i}^{α}}$$

where Cᵢ is the polymer concentration in the slice i in the polymer peak, and [ηᵢ]_{b} is the viscosity of the branched polymer in slice i of the polymer peak, and Mᵢ is the weight averaged molecular weight in slice i of the polymer peak measured by light scattering, K and α are as defined above.

### Crystallization Temperature

In one embodiment the polymer described above has a crystallization temperature (Tc) between 20 and 110° C. In some embodiments the Tc is between 70 to 100° C. In other embodiments the Tc is between 30° C. to 80° C., 30° C. to 50° C., and 60° C. to 80° C.

### Viscosity

The propylene polymer can have a viscosity of less than 50,000 mPa sec when measured at 190° C. using a Brookfield viscometer. For example, the viscosity of the propylene polymer can be less than about 35,000 mPa sec, less than 35,000 mPa sec, less than 25,000 mPa sec, less than 20,000 mPa sec, less than 15,000 mPa sec, less than 10,000 mPa sec, less than 5,000 mPa sec, or less than 1,000 mPa sec. In one or more embodiments, the viscosity of the propylene polymer can range from a low of about 500 mPa sec, 2,000 mPa sec, or 6,000 mPa sec to a high of about 10,000 mPa sec, 15,000 mPa sec, 30,000 mPa sec, or 35,000 mPa sec. In one or more embodiments, the viscosity of the propylene polymer can range from a low of about 500 mPa sec, 1,200 mPa sec, or 3,200 mPa sec to a high of about 8,000 mPa sec, 12,000 mPa sec, or 24,000 mPa sec.

### Process for Producing the Polymer

The propylene polymer can be produced using any polymerization process. Suitable polymerization processes include, but are not limited to, high pressure, slurry, gas, bulk, suspension, supercritical, solution phase, and combinations thereof. Polymerization may be carried out by a continuous, a semi-continuous, or batch process and may include use of one or more chain transfer agents, scavengers, or other such additives. By continuous, it is meant a system that operates (or is intended to operate) without interruption or cessation. For example, a continuous process would be one where the reactants are continually introduced into one or more reactors and polymer product is continually withdrawn.

### Catalyst

Single-site metallocene catalysts or catalyst systems are preferred. Suitable single site metallocene catalysts for use herein include those obeying the following general formula (1):

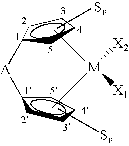

wherein:

M is a Group 3, 4, 5 or 6 transition metal atom, or a lanthanide metal atom, or actinide metal atom, preferably a Group 4 transition metal atom selected from titanium, zirconium or hafnium;

each cyclopentadienyl (Cp) ring is substituted with from zero to four substituent groups S, each substituent group S being, independently, a hydrocarbyl, substituted-hydrocarbyl, halocarbyl, substituted-halocarbyl, hydrocarbyl-substituted organometalloid, halocarbyl-substituted organometalloid, disubstituted boron, disubstituted pnictogen, substituted chalcogen or halogen radical, provided that two adjacent S groups may joined to form a C₄ to C₂₀ ring to give a saturated or unsaturated polycyclic ligand;

the subscript “v” denotes the carbon atom on the Cp-ring to which the substituent is bonded;

A is a bridging group; and

X₁ and X₂ are, independently, hydride radicals, hydrocarbyl radicals, substituted hydrocarbyl radicals, halocarbyl radicals, substituted halocarbyl radicals, and hydrocarbyl- and halocarbyl-substituted organometalloid radicals, substituted pnictogen radicals, or substituted chalcogen radicals; or X₁ and X₂ are joined and bound to the metal atom to form a metallacycle ring containing from about 3 to about 20 carbon atoms; or X₁ and X₂ together can be an olefin, diolefin or aryne ligand; or when Lewis-acid activators, such as methylalumoxane, which are capable of donating an X₁ ligand as described above to the transition metal component are used, X₁ and X₂ may independently be a halogen, alkoxide, aryloxide, amide, phosphide or other univalent anionic ligand or both X₁ and X₂ can also be joined to form a anionic chelating ligand and with the proviso that X₁ and X₂ are not a substituted or unsubstituted cyclopentadienyl ring.

Preferably, A is a bridging group containing boron or a Group 14, 15 or 16 element. Examples of suitable bridging groups include R′₂C, R′₂Si, R′₂Ge, R′₂CCR′₂, R′₂CCR′₂CR′₂, R′₂CCR′₂CR′₂CR′₂, R′C═CR′, R′C═CR′CR′₂, R′₂CCR′═CR′CR′₂, R′C═CR′ CR′═CR′, R′C═CR′CR′₂CR′₂, R′₂CSiR′₂, R′₂SiSiR′₂, R′₂CSiR′₂CR′₂, R′₂SiCR′₂SiR′₂, R′C═CR′SiR′₂, R′₂CGeR′₂, R′₂GeGeR′₂, R′₂CGeR′₂CR′₂, R′₂GeCR′₂GeR′₂, R′₂SiGeR′₂, R′C═CR′GeR′₂, R′B, R′₂C—BR′, R′₂C—BR′—CR′₂, R′N, R′P, O, S, Se, R′₂C—O—CR′₂, R′₂CR′₂C—O—CR′₂CR′₂, R′₂C—O—CR′₂CR′₂, R′₂C—O—CR′—CR′, R′₂C—S—CR′₂, R′₂CR′₂C—S—CR′₂CR′₂, R′₂C—S—CR′₂CR′₂, R′₂C—S—CR′═CR′, R′₂C—Se—CR′₂, R′₂CR′₂C—Se—CR′₂CR′₂, R′₂C—Se—CR′₂CR′₂, R′₂C—Se—CR′═CR′, R′₂C—N═CR′, R′₂C—NR′—CR′₂, R′₂C—NR′—CR′₂CR′₂, R′₂C—NR′—CR′═CR′, R′₂CR′₂C—NR′—CR′₂CR′₂, R′₂C—P═CR′, and R′₂C—PR′—CR′₂ where R′ is hydrogen or a C₁-C₂₀ containing hydrocarbyl, substituted hydrocarbyl, halocarbyl, substituted halocarbyl, silylcarbyl or germylcarbyl substituent and optionally two or more adjacent R′ may join to form a substituted or unsubstituted, saturated, partially unsaturated or aromatic, cyclic or polycyclic substituent. Preferred examples for the bridging group Y include CH₂, CH₂CH₂, CH(CH₃)₂, O, S, SiMe₂, SiPh₂, SiMePh, Si(CH₂)₃ and Si(CH₂)₄.

The transition metal compounds described above are typically activated in various ways to yield compounds having a vacant coordination site that will coordinate, insert, and polymerize olefin(s). For the purposes of this patent specification and appended claims, the terms “cocatalyst” and “activator” are used herein interchangeably and are defined to be any compound which can activate any one of the catalyst compounds described above by converting the neutral catalyst compound to a catalytically active catalyst compound cation. Non-limiting activators, for example, include alumoxanes, aluminum alkyls, ionizing activators, which may be neutral or ionic, and conventional-type cocatalysts. Preferred activators typically include alumoxane compounds, modified alumoxane compounds, and ionizing anion precursor compounds that abstract one reactive, σ-bound, metal ligand making the metal complex cationic and providing a charge-balancing noncoordinating or weakly coordinating anion.

In addition to or in place of the alumoxane, the transition metal compounds described herein can be activated by an ionizing or stoichiometric activator, neutral or ionic, such as tri (n-butyl) ammonium tetrakis (pentafluorophenyl) boron, a trisperfluorophenyl boron metalloid precursor or a trisperfluoronaphtyl boron metalloid precursor, polyhalogenated heteroborane anions (WO 98/43983), boric acid (U.S. Pat. No. 5,942,459) or combination thereof.

Ionic stoichiometric activator compounds may contain an active proton, or some other cation associated with, but not coordinated to, or only loosely coordinated to, the remaining ion of the ionizing compound. Such compounds and the like are described in European publications EP-A-0 570 982, EP-A-0 520 732, EP-A-0 495 375, EP-B1-0 500 944, EP-A-0 277 003 and EP-A-0 277 004, and U.S. Pat. Nos. 5,153,157, 5,198,401, 5,066,741, 5,206,197, 5,241,025, 5,384,299 and 5,502,124, all of which are herein fully incorporated by reference. Ionic catalysts can be prepared by reacting a transition metal compound with a neutral Lewis acid, such as B(C₆F₆)₃, which upon reaction with the hydrolyzable ligand (X) of the transition metal compound forms an anion, such as ([B(C₆F₅)₃(X)]⁻), which stabilizes the cationic transition metal species generated by the reaction.

Compounds useful as an activator component in the preparation of the ionic catalyst systems used in the process of this invention comprise a cation, which is preferably a Bronsted acid capable of donating a proton, and a compatible non-coordinating anion which anion is relatively large (bulky), capable of stabilizing the active catalyst species (the Group 4 cation) which is formed when the two compounds are combined and said anion will be sufficiently labile to be displaced by olefinic diolefinic and acetylenically unsaturated substrates or other neutral Lewis bases such as ethers, nitriles and the like. Two classes of compatible non-coordinating anions have been disclosed in EPA 277,003 and EPA 277,004 published 1988: 1) anionic coordination complexes comprising a plurality of lipophilic radicals covalently coordinated to and shielding a central charge-bearing metal or metalloid core, and 2) anions comprising a plurality of boron atoms such as carboranes, metallacarboranes and boranes.

In a preferred embodiment, the stoichiometric activators include a cation and an anion component, and may be represented by the following formula:

(L-H)_{d}⁺(A^{d-})

wherein:

L is an neutral Lewis base;

H is hydrogen;

(L-H)⁺ is a Bronsted acid;

A^{d-} is a non-coordinating anion having the charge d−; and

d is an integer from 1 to 3.

The cation component, (L-H)_{d}⁺ may include Bronsted acids such as protons or protonated Lewis bases or reducible Lewis acids capable of protonating or abstracting a moiety, such as an alkyl or aryl, from the bulky ligand metallocene containing transition metal catalyst precursor, resulting in a cationic transition metal species.

The anion component A^{d} include those having the formula [M^{k+}Qₙ]^{d-} wherein k is an integer from 1 to 3; n is an integer from 2-6; n−k=d; M is an element selected from Group 13 of the Periodic Table of the Elements, preferably boron or aluminum, and Q is independently a hydride, bridged or unbridged dialkylamido, halide, alkoxide, aryloxide, hydrocarbyl, substituted hydrocarbyl, halocarbyl, substituted halocarbyl, and halosubstituted-hydrocarbyl radicals, said Q having up to 20 carbon atoms with the proviso that in not more than 1 occurrence is Q a halide. Preferably, each Q is a fluorinated hydrocarbyl group having 1 to 20 carbon atoms, more preferably each Q is a fluorinated aryl group, and most preferably each Q is a pentafluoryl aryl group. Examples of suitable A^{d-} also include diboron compounds as disclosed in U.S. Pat. No. 5,447,895, which is fully incorporated herein by reference.

Illustrative, but not limiting examples of the ionic stoichiometric activator (L−H)_{d}⁺(A^{d-}) is N,N-dimethylanilinium tetra(perfluorophenyl)borate, N,N-dimethylanilinium tetrakis(perfluoronapthyl)borate, N,N-dimethylanilinium tetrakis(perfluorobiphenyl)borate, N,N-dimethylanilinium tetrakis(3,5-bis(trifluoromethyl)phenyl)borate, triphenylcarbenium tetrakis(perfluoronapthyl)borate, triphenylcarbenium tetrakis (perfluorobiphenyl)borate, triphenylcarbenium tetrakis (3,5-bis(trifluoromethyl)phenyl)borate, or triphenylcarbenium tetra(perfluorophenyl)borate.

### Formulation of Coatings

The propylene polymer can be used directly as a coating or blended with one or more components to form a coating composition. Examples of such other components include waxes and functionalized polyolefins. However, in view of the low viscosity of the propylene polymer, the blends can contain less than 20 wt %, such as no more than 10 wt %, of such other components.

In one embodiment, the propylene polymer is blended with a functionalized polyolefin such that the resulting coating composition comprises up to 20 wt %, for example from 0.1 to 20 wt %, 0.1 to 15 wt %, 0.1 to 10 wt %, 0.5 to 10 wt %, and 1 to 5 wt %, of the functionalized polyolefin. By functionalized is meant that the polymer has been contacted with an unsaturated acid or anhydride. Preferred unsaturated acids or anhydrides include any unsaturated organic compound containing at least one double bond and at least one carbonyl group. Representative acids include carboxylic acids, anhydrides, esters and their salts, both metallic and non-metallic. Preferably, the organic compound contains an ethylenic unsaturation conjugated with a carbonyl group (—C═O). Examples include maleic, fumaric, acrylic, methacrylic, itaconic, crotonic, alpha-methyl crotonic, and cinnamic acids as well as their anhydrides, esters and salt derivatives. Particularly preferred functional groups include maleic acid and maleic anhydride. Maleic anhydride is particularly preferred. The unsaturated acid or anhydride is preferably present at about 0.1 wt % to about 10 wt %, preferably at about 0.5 wt % to about 7 wt %, even more preferably at about 1 to about 4 wt %, based upon the weight of the hydrocarbon resin and the unsaturated acid or anhydride. In one preferred embodiment the functionalized polyolefin is maleated polyolefin, more preferably a maleated polypropylene.

In another embodiment, the propylene polymer is blended with a wax, either alone or in combination with a functionalized polyolefin such that the resulting coating composition comprises up to 20 wt %, for example from 0.1 to 20 wt % or from 2 to 10 wt %, of the wax. Suitable waxes include polar waxes, non-polar waxes, Fischer-Tropsch waxes, oxidized Fischer-Tropsch waxes, hydroxystearamide waxes, functionalized waxes, polypropylene waxes, polyethylene waxes, wax modifiers, and combinations thereof.

In addition, tackifiers may be used with the propylene polymer of this invention. Examples of suitable tackifiers, include, but are not limited to, aliphatic hydrocarbon resins, aromatic modified aliphatic hydrocarbon resins, hydrogenated polycyclopentadiene resins, polycyclopentadiene resins, gum rosins, gum rosin esters, wood rosins, wood rosin esters, tall oil rosins, tall oil rosin esters, polyterpenes, aromatic modified polyterpenes, terpene phenolics, aromatic modified hydrogenated polycyclopentadiene resins, hydrogenated aliphatic resin, hydrogenated aliphatic aromatic resins, hydrogenated terpenes and modified terpenes, hydrogenated rosin acids, and hydrogenated rosin esters. In some embodiments the tackifier is hydrogenated.

In other embodiments the tackifier is non-polar, by which is meant that the tackifier is substantially free of monomers having polar groups. Preferably the polar groups are not present, however if present, they comprise not more than 5 wt %, preferably not more than 2 wt %, even more preferably no more than 0.5 wt %, of the tackifier. In some embodiments the tackifier has a softening point (Ring and Ball, as measured by ASTM E-28) of 80° C. to 150° C., preferably 100° C. to 130° C. In another embodiment the resin is liquid and has a R and B softening point of between 10 and 70° C.

The tackifier, if present, is typically present at about 1 wt % to about 80 wt %, such as about 2 to about 60 wt %, for example about 10 to about 30 wt %, based on total weight of the coating composition. In one or more embodiments, the tackifier can range from a low of about 5 wt %, 15 wt % or 25 wt % to a high of about 60 wt %, 70 wt % or 80 wt %, based on total weight of the coating composition. In one or more embodiments, the tackifier can range from a low of about 1 wt %, 5 wt % or 10 wt % to a high of about 15 wt %, 20 wt % or 30 wt %, based on total weight of the coating composition.

Preferred hydrocarbon resins for use as tackifiers or modifiers include:

(a) Resins such as C5/C6 terpene resins, styrene terpenes, alpha-methyl styrene terpene resins, C9 terpene resins, aromatic modified C5/C6, aromatic modified cyclic resins, aromatic modified dicyclopentadiene based resins or mixtures thereof. Additional preferred resins include those described in WO 91/07472, U.S. Pat. No. 5,571,867, U.S. Pat. No. 5,171,793 and U.S. Pat. No. 4,078,132. Typically these resins are obtained from the cationic polymerization of compositions containing one or more of the following monomers: C5 diolefins (such as 1-3 pentadiene, isoprene, etc); C5 olefins (such as 2-methylbutenes, cyclopentene, etc.); C6 olefins (such as hexene), C9 vinylaromatics (such as styrene, alpha methyl styrene, vinyltoluene, indene, methyl indene, etc.); cyclics (such as dicyclopentadiene, methyldicyclopentadiene, etc.); and or terpenes (such as limonene, carene, etc).

(b) Resins obtained by the thermal polymerization of dicyclopentadiene, and/or the thermal polymerization of dimers or oligomers of cyclopentadiene and/or methylcyclopentadiene, optionally with vinylaromatics (such as styrene, alpha-methyl styrene, vinyl toluene, indene, methyl indene).

In yet another aspect, the coating composition can include 15% by weight or less, or 10% by weight or less, or 5% by weight or less of one or more additives selected from plasticizers, oils, stabilizers, antioxidants, pigments, dyestuffs, antiblock additives, polymeric additives, defoamers, preservatives, thickeners, adhesion promoters, rheology modifiers, humectants, fillers, surfactants, processing aids, cross-linking agents, neutralizing agents, flame retardants, fluorescing agents, compatibilizers, antimicrobial agents, and water.

Exemplary oils may include aliphatic naphthenic oils, white oils, and combinations thereof, for example. The phthalates may include di-iso-undecyl phthalate (DIUP), di-iso-nonylphthalate (DINP), dioctylphthalates (DOP), combinations thereof, or derivatives thereof. Exemplary polymeric additives include homo poly-alpha-olefins, copolymers of alpha-olefins, copolymers and terpolymers of diolefins, elastomers, polyesters, block copolymers including diblocks and triblocks, ester polymers, alkyl acrylate polymers, and acrylate polymers. Exemplary plasticizers may include mineral oils, polybutenes, phthalates, and combinations thereof. Exemplary anti-oxidants include alkylated phenols, hindered phenols, and phenol derivatives, such as t-butyl hydroquinone, butylated hydroxyanisole, polybutylated bisphenol, butylated hydroxy toluene (BHT), alkylated hydroquinone, 2,6-di-tert-butyl-paracresol, 2,5-di-tert-aryl hydroquinone, octadecyl-3-(3,5-di-tert-butyl-4-hydroxy phenyl), etc.

Exemplary fillers include silica, diatomaceous earth, calcium carbonate, iron oxide, hydrogenated castor oil, fumed silica, precipitated calcium carbonate, hydrophobic treated fumed silicas, hydrophobic precipitated calcium carbonates, talc, zinc oxides, polyvinyl chloride powders, fungicides, graphite, carbon black, asphalt, carbon fillers, clay, mica, fibers, titanium dioxide, cadmium sulfide, asbestos, wood flour, polyethylene powder, chopped fibers, bubbles, beads, thixotropes, bentonite, calcium sulfate, calcium oxide, magnesium oxide, and combinations or derivates thereof. Exemplary surfactants include vinyl-containing or mercapto-containing polyorganosiloxanes, macromonomers with vinyl terminated polydimethyl siloxane, and combinations or derivatives thereof.

Exemplary adhesion promoters include silanes, titanates, organosylane, acrylics, acids, anhydrides, epoxy resins, hardening agents, polyamides, methylacrylates, epoxies, phenolic resins, polyisobutylene, aminoalkyl, mercaptoalkyl, epoxyalkyl, ureidoalkyl, carboxy, acrylate and isocyanurate functional silanes, mercaptopropyltrimethoxysilane, glycidoxpropyltrimethoxysilane, aminopropyltriethoxysilane, aminoethylaminopropyltrimethoxysilane, ureidopropyltrimethyloxysilane, bis-gamma-trimethoxysilyl-propylurea, 1,3,5-tris-gamma-trimethoxysilylpropylisocyanurate, bis-gamma-trimethoxysilylpropylmaleate, fumarate and gamma-methacryloxypropyltrimethoxysilane, aminopropyltriethoxysilane, and combinations and derivatives thereof. Exemplary crosslinking agents include oxime crosslinkers, alkoxysilanes, epoxyalkylalkoxysilanes, amido silanes, aminosilanes, enoxysilanes, tetraethoxysilanes, methyltrimethoxy silane, vinyl trimethoxysilane, glycidoxypropyltrimethoxsilane, vinyl tris-isopropenoxysilane, methyl tris-isopropenoxysilane, methyl tris-cyclohexylaminosilane, methyl tris-secondarybutylaminosilane, polyisocyanates, and combinations or derivatives thereof. Exemplary organic solvents include aliphatic solvents, cycloaliphatic solvents, mineral spirits, aromatic solvents, hexane, cyclohexane, benzene, toluene, xylene, and combinations or derivatives thereof.

Exemplary stabilizers include hindered phenols, sulfur phenols, phosphorous-containing phenols, 1,3,5-trimethyl-2,4,6-tris(3-5-di-tert-butyl-4-hydroxybenzyl)benzene, pentaerythritol tetrakis-3(3,5-di-tert-butyl-4-hydroxyphenyl)propionate, n-octadecyl-3(3,5-di-tert-butyl-4-hydroxyphenyl) propionate, 4,4′-methylenebis(4-methyl-6-tert butylphenol), 4,4′-thiobis(6-tertbutyl-o-cresol), 2,6-di-tert-butylphenol, 6-(4-hydroxyphenoxy)-2,4-bis(n-ocytlthio)-1,3,5-triazine, 2,4,6-tris(4-hydroxy-3,5-di-tert-butyl-phenoxy)-1,3,5-triazine, di-n-octadecyl-3,5-di-tert-butyl-4-hydroxybenzylphosphonate, 2-(n-octylthio)ethyl-3,5-di-tert-butyl-4-hydroxybenzoate, sorbitol hexa-(3,3,5-di-tertbutyl-4-hydroxy-phenyl) propionate, and combinations or derivatives thereof. In one aspect, the coating composition includes from 0.1 to 3 percent by weight of the one or more stabilizers.

In another embodiment, the propylene polymer can be blended with one or more additional polymers to produce a blend in which the polymer is present in an amount of from 10 to 99 wt %, preferably 20 to 95 wt %, even more preferably at least 30 to 90 wt %, even more preferably 40 to 90 wt %, even more preferably 50 to 90 wt %, even more preferably 60 to 90 wt %, even more preferably 70 to 90 wt %, based upon the total weight of the composition. Such blends may be produced by mixing the two or more polymers together, by connecting reactors together in series to make reactor blends or by using more than one catalyst in the same reactor to produce multiple species of polymer. The polymers can be mixed together prior to being put into the extruder or may be mixed in an extruder.

Suitable polymers for producing blends with the propylene polymer include elastomers (preferred elastomers include all natural and synthetic rubbers, including those defined in ASTM D1566). In a preferred embodiment, the coating composition comprises more than 5 wt %, 10 wt %, 15 wt %, 20 wt %, 25 wt %, 30 wt %, 35 wt %, and 40 wt % of the elastomers. In a preferred embodiment, the coating composition comprises from 0.1 wt %, 1.0 wt %, 5 wt % on the low end to 20 wt %, 30 wt %, and 40 wt % on the high end. In a preferred embodiment, the elastomers are blended with the propylene polymer to form rubber toughened compositions. In a particularly preferred embodiment the rubber toughened composition is a two (or more) phase system where the rubber is a discontinuous phase and the propylene polymer is a continuous phase. Examples of preferred elastomers include one or more of the following: ethylene propylene rubber, ethylene propylene diene monomer rubber, neoprene rubber, styrenic block copolymer rubbers (including SI, SIS, SB, SBS, SIBS, SEBS, SEPS, and the like (S is styrene, I is isoprene, B is butadiene, EB is ethylenebutylene, EP is ethylenepropylene), butyl rubber, halobutyl rubber, copolymers of isobutylene and para-alkylstyrene, halogenated copolymers of isobutylene and para-alkylstyrene. This blend may be combined with the tackifiers and/or other additives as described above.

In another embodiment, the propylene polymer can be blended with one or more impact copolymers. Impact copolymers are defined to be a blend of isotactic PP and an elastomer such as an ethylene-propylene rubber. In a preferred embodiment, the blend is a two (or more) phase system where the impact copolymer is a discontinuous phase and the polymer is a continuous phase. The resulting blend can also be combined with the tackifiers and/or other additives as described above.

In another embodiment, the propylene polymer can be blended with one or more ester polymers. In a preferred embodiment, the blend is a two (or more) phase system where the polyester is a discontinuous phase and the polymer is a continuous phase. The resulting blend can also be combined with the tackifiers and/or other additives as described above.

In a preferred embodiment, the propylene polymer is combined with one or more thermoplastics, such as metallocene polyethylenes (mPE's) and/or metallocene polypropylenes (mPP's). The mPE and mPP homopolymers or copolymers are typically produced using mono- or bis-cyclopentadienyl transition metal catalysts in combination with an activator of alumoxane and/or a non-coordinating anion in solution, slurry, high pressure or gas phase. The catalyst and activator may be supported or unsupported and the cyclopentadienyl rings may be substituted or unsubstituted. Several commercial products produced with such catalyst/activator combinations are commercially available from ExxonMobil Chemical Company in Baytown, Texas, under the tradenames EXCEED™, ACHIEVE™ and EXACT™. For more information on the methods and catalysts/activators to produce such mPE homopolymers and copolymers see WO 94/26816; WO 94/03506; EPA 277,003; EPA 277,004; U.S. Pat. No. 5,153,157; U.S. Pat. No. 5,198,401; U.S. Pat. No. 5,240,894; U.S. Pat. No. 5,017,714; CA 1,268,753; U.S. Pat. No. 5,324,800; EPA 129,368; U.S. Pat. No. 5,264,405; EPA 520,732; WO 92 00333; U.S. Pat. No. 5,096,867; U.S. Pat. No. 5,507,475; EPA 426 637; EPA 573 403; EPA 520 732; EPA 495 375; EPA 500 944; EPA 570 982; WO91/09882; WO94/03506 and U.S. Pat. No. 5,055,438. The resulting blend can also be combined with the tackifiers and/or other additives as described above.

### Mechanical Properties of Composition

Coating compositions containing the propylene polymers described herein exhibit a novel and advantageous balance of properties including: a toughness of greater than 3.4 megajoule/m³ when the viscosity at 190° C. is less than 1000 mPa sec; a toughness of greater than 7 megajoule/m³ and an elongation of 100% or more when viscosity at 190° C. is in a range from 1000 to 10,000 mPa sec; and a toughness of greater than 14 megajoule/m³ and an elongation of 400% or more when the viscosity at 190° C. is greater than 10,000 mPa sec.

In preferred embodiments, the coating compositions have a Shear Adhesion Fail Temperature (SAFT) of at least 100° C., a viscosity of less than 25,000 mPa sec, such as less than 10,000 mPa sec, for example less than 5,000 mPa sec, typically less than 1,000 mPa sec at 190° C., and a set time of less than 3 seconds, typically less than 2 seconds.

Shore A hardness was measured according to ASTM 2240. An air cooled dot of coating was subjected to the needle and the deflection was recorded from the scale.

In an embodiment, the coating composition described herein has a Shore A Hardness (as measured by ASTM 2240) of 95 or less, 70 or less, or 60 or less, or 50 or less, or 40 or less or 30 or less, or 20 or less. In other embodiments the Shore A Hardness is 5 or more, 10 or more, or 15 or more.

Coating melt viscosity and viscosity profiles vs. temperature were measured using a Brookfield digital viscometer and a number 27 spindle according to ASTM D-3236.

SAFT (modified ASTM D 4498-00) measures the ability of a bond to withstand an elevated temperature rising at 10° F. (5.5° C.)/15 min., under a constant force that pulls the bond in the shear mode. Bonds were formed in the manner described above on Kraft paper (1 inch by 3 inch (2.5 cm×7.6 cm)). The test specimens were suspended vertically in an oven at room temperature with a 500-gram load attached to the bottom. The temperatures at which the weight fell were recorded (when the occasional sample reached temperatures above the oven capacity >265° F. (129° C.) it was terminated and averaged in with the other samples at termination temperature).

Peel Adhesion Failure Temperature (PAFT) was determined using following procedure modified according to the procedure of TAPPI T814 PM-77. Two sheets of 6″×12″ Kraft paper were laminated together with a one inch strip of molten coating heated to 177° C. The laminated sheet was trimmed and cut into 1-inch wide strips. These strips were placed in an oven with a 100-gram of weight hanging in a peel mode. The over temperature increased at a rate of 30° C. per hour. The samples were hung from a switch that trips when the samples fail to record the temperature of failure.

Cloud point is determined by heating the coating blends to 121° C. and applying a small bead (approximately 1 gram) of the molten coating to the bulb of an ASTM thermometer. The temperature at which the molten coating clouds over is then noted. These measures of cloud point provide an indication of a coating's overall compatibility, i.e., the compatibility of the individual ingredients with each other.

Plaques suitable for physical property testing were compression molded on a Carver hydraulic press. 6.5 g of polymer was molded between brass plates (0.05″ thick) lined with Teflon coated aluminum foil. A 0.033″ thick chase with a square opening 4″×4″ was used to control sample thickness. After one minute of preheat at 170° C., under minimal pressure, the hydraulic load was gradually increased to ˜10,000-15,000 lbs., at which it was held for three minutes. Subsequently the sample and molding plates were cooled for three minutes under ˜10,000 to 15,000 lbs. load between the water cooled platens of the press. Plaques were allowed to equilibrate at room temperature for a minimum of two days prior to physical property testing.

Dog bones for tensile testing were cut from compression molded plaques using a mallet handle die. Specimen dimensions were those specified in ASTM D 1708 unless otherwise noted. Tensile properties were measured on an Instron™ model 4502 equipped with a 22.48 lb. load cell and pneumatic jaws fitted with serrated grip faces. Deformation was performed at a constant crosshead speed of 5.0 in/min with a data sampling rate of 25 points/second. Jaw separation prior to testing was 0.876″, from which strains were calculated assuming affine deformation. Initial modulus, stress and strain at yield (where evident), peak stress, tensile strength at break, and strain at break were calculated. A minimum of five specimens from each plaque was tested, the results being reported as the average value. All stresses quoted were calculated based upon the original cross-sectional area of the specimen, taking no account of reduced cross-section as a function of increasing strain. Tensile strength is defined as the maximum tensile stress. Toughness is defined as the ability of polymer to absorb applied energy. The area under the stress-strain curve is used as a measure of the toughness.

The color of polymers and their blends can be measured using Gardner index (Gardner color scale) according to ASTM D 1544-04.

### End-Uses

The propylene polymer can be applied to any article or substrate using well known techniques such as multiple tiered dipping, spraying (meltblown, etc), multi-layered topographical printing, gradient placement, or other techniques that deliver a multiplicity of functionality through placement location and/or texture. The propylene polymer can be used to provide or serve as an insulation, both electrical and thermal, comfortable grip, non-slip, higher torque, easy grip, decorative, sound damping, moisture and rust resistance, scratch resistance. Additionally, the coating can be applied to enhance the grip of an article. In another embodiment, the coating can be formulated and applied to be easily peeled off so that the article or substrate is protected during shipment and the coating is pealed off for final use. The coating can also be applied in a gradient such that it tapers from one edge to the other edge of an article.

The low molecular weight propylene polymer can be a coating composition that adheres to an article or substrate. One feature is that the coating composition can attach itself to the article even if the adhesion to the article is poor. The method of attachment can be attributed to entanglement, entrapment, partial or full encapsulation. For example, a bead of polymer coating can be applied to an object and it will remain attached to the object via friction, entanglement, or entrapment. Accordingly, the coating can be applied as a full coating, crack coating, seam coating, internal coating, hole coating, crevice coating, depression coating, netting coating, and/or partial coating. The polymer can be applied to either the inside or the outside of an article or substrate. In a preferred embodiment, the propylene polymer can be dipped or squirted into a crack, seam, crevice, or depression in an article or substrate such that the polymer becomes entangled or entrapped.

Preferred articles include wood, paper, cardboard, plastic, thermoplastic, rubber, metal, metal foil (such as aluminum foil and tin foil), metallized surfaces, cloth, non-wovens (particularly polypropylene spun bonded fibers or non-wovens), spunbonded fibers, cardboard, stone, plaster, glass (including silicon oxide (SiOₓ) coatings applied by evaporating silicon oxide onto a film surface), foam, rock, ceramics, films, polymer foams (such as polyurethane foam), substrates coated with inks, dyes, pigments, PVDC and the like or combinations thereof.

Additional preferred articles include polyethylene, polypropylene, polyacrylates, acrylics, polyethylene terephthalate, or any of the polymers listed above as suitable for blends. Any of the above substrates, and/or the polymers of this invention, may be corona discharge treated, flame treated, electron beam irradiated, gamma irradiated, microwaved, or silanized.

In a particular embodiment, the propylene polymer or coating composition comprising the propylene polymer can be used as a coating for a packaging article. The packaging article may be a carton, container, crate, case, corrugated case, or tray, for example. More particularly, the packaging article may be a cereal product, cracker product, beer packaging, frozen food product, paper bag, drinking cup, milk carton, juice carton, drinking cup, or as a container for shipping produce, just to name a few exemplary uses.

The packaging substrate to which the polymer coated may be formed from paper, paperboard, containerboard, tagboard, corrugated board, chipboard, kraft, cardboard, fiberboard, plastic resin, metal, metal alloys, foil, film, plastic film, laminates, sheeting, or any combination thereof. In one aspect, the coating composition may be used to bind or bond two or more packaging elements together wherein the packaging elements are formed from the same or different type of materials. Accordingly, the packaging elements may be individually formed from paper, paperboard, containerboard, tagboard, corrugated board, chipboard, kraft, cardboard, fiberboard, plastic resin, metal, metal alloys, foil, film, plastic film, laminates, sheeting, or any combination thereof. The one or more packaging elements may also be individually coated using paper, foil, metal, metal alloys, polyethylene, polypropylene, polyester, polyethylene terephthalate, polyvinyl chloride, polyvinylidine chloride, polyvinyl acetate, polyamides, homopolymers thereof, and combinations and copolymers thereof.

In a particular embodiment, the propylene polymer or coating composition comprising the propylene polymer can be used as a functional coating for a handles such as handles for tools and sports equipment. In essence, the coating composition is used to enhance the grip of the handle. Preferably, the handle is harder than the coating composition such as handles made of metal, wood, fiberglass composites, graphite composites, ceramics, thermoplastics, and the like.

Other illustrative articles include, but are not limited to, consumer products, handles, pipes, valve handles, hand tools such as pliers, screw drivers, safety glasses, bottle caps, serving utensils, eating utensils, serving trays, table tops, gloves, shoes, shoe soles, furniture, bottom side of walkoff mats, dropclothes, and container bottoms. The coating can also be textured and/or colored for decorative or other purposes.

### Coating Application

In at least one specific embodiment, the coating composition can be melted in a small melt tank, and the uncoated article or substrate can be dipped in the molten coating. The coated article/substrate can be removed, allowing a thin polymer coating layer to remain on the article or substrate, and then cooled. The coating can be applied in two dimensional patterns or three dimensional patterns. This can provide design effects, or gripping effects, or other desirable textures and patterns. Additionally, the coating may be applied in layers.

Preferably, the coating composition is melted at a temperature of no greater than 30° C., 25° C., 20° C., 15° C., 10° C., or 5° C. above the melting point of the polypropylene polymer.

Preferably, the coating composition is applied to thermoplastic resin articles having a softening point (Ring and Ball, as measured by ASTM E-28) that is greater than the temperature of the molten coating. Preferably, the coating composition is applied to plastic articles having a softening point that is greater than the melting point of the propylene polymer.

Preferably, the coating composition has a first side adhering to the article to be coated and a second side substantially free of an additional substrate in which to adhere. Preferably, the second side of the coating is free of any additional substrate in which to adhere. Although the coating composition can be used as an adhesive to bind two or more substrates, it is preferred that the coating composition described and claimed herein form a coating over an article that when cooled will improve or modify the surface properties of the article.

Preferably, the final coating will have a thickness greater than 250 micrometers, greater than 1000 micrometers, greater than 2000 micrometers, greater than 3000 micrometers, greater than 4000 micrometers, greater than 5000 micrometers, or greater than 1 centimeter. Preferably, the final coating will have a substantially uniform thickness, however, the coating may be applied to taper to make a non-uniform thickness.

### Specific Coating Formulations

One formulation of the coating composition comprises at least 80 percent by weight of the propylene polymer, up to 10 percent by weight of one or more tackifiers, up to 10 percent by weight of one or more waxes, and up to 15 percent by weight of one or more additives. Another typical formulation of the coating composition comprises at least 85 percent by weight of the propylene polymer, up to 5 percent by weight of one or more tackifiers, up to 5 percent by weight of one or more waxes, up to 10 percent by weight of functionalized polyolefin and up to 15 percent by weight of one or more additives. Yet another typical formulation of the coating composition comprises at least 90 percent by weight of the propylene polymer, up to 5 percent by weight of one or more tackifiers, up to 5 percent by weight of one or more waxes, up to 10 percent by weight of functionalized polyolefin and up to 10 percent by weight of one or more additives.

Preferably, the coating composition does not contain any hydrocarbon solvents or conventional plasticizers. Among the more important conventional plasticizers are nonvolatile organic liquids and low melting solids (e.g., phthalate, adipate, and sebacate esters), polyols such as ethylene gycol and its derivatives, tricresyl phosphate, castor oil, etc. Hydrocarbon solvent groups include aromatics, aliphatics, esters, ethers, ketones, amines, and nitrated and chlorinated hydrocarbons. It is desired to not use hydrocarbon solvents because many solvents are flammable and toxic to varying degrees.

The invention will now be more particularly described with reference to the following non-limiting Examples.

In the Examples, the hexene-1 content was determined using C-13 NMR. In preparation of a polymer for C-13 NMR analysis about 0.2-0.3 grams of polymer was dissolved in about 3 ml of deuterated tetrachloroethane in a 10-mm diameter NMR tube at about 120° C., then the sample solution was placed into a NMR spectrometer with the probe temperature set to 120° C. Spectral data was collected for at least four hours using an observe pulse angle of less than 90 degrees, ungated proton decoupling and a delay time long enough to allow adequate quantification of the NMR signals of interest. Interpretation of the data is based in part on peak assignments provided by Kissin and Brandolini (Macromolecules, 24, 2632, (1991)), Folini, et al., (Macromol. Chem. Phys., 201, 401 (2000)) and Resconi, et al., (Chem. Rev., 100, 1253, (2000). Instrument measured integral intensities were used to determine sample composition.

### Example 1

All polymerizations were performed in a liquid filled, single-stage continuous reactor using a metallocene catalyst system. The reactor was a 0.5-liter stainless steel autoclave reactor and was equipped with a stirrer, a water cooling/steam heating element with a temperature controller, and a pressure controller. Solvents, propylene, and comonomers (such as 1-hexene and 1-octene) were first purified by passing through a three-column purification system. The purification system consisted of an Oxiclear column (Model # RGP-R1-500 from Labelear) followed by a 5A and a 3A molecular sieve columns. Purification columns were regenerated periodically whenever there was evidence of lower activity of polymerization. Both the 3A and 5A molecular sieve columns were regenerated in-house under nitrogen at a set temperature of 260° C. and 315° C., respectively. The molecular sieve material was purchased from Aldrich. Oxiclear column was regenerated in the original manufacture. The purified solvents and monomers were then chilled to about—15° C. by passing through a chiller before being fed into the reactor through a manifold. Solvent and monomers were mixed in the manifold and fed into reactor through a single tube. All liquid flow rates were measured using Brooksfield mass flow meters or Micro-Motion Coriolis-type flow meters.

The catalyst was rac-dimethylsilylbis(2-methyl-4-phenylindenyl) zirconium dimethyl (obtained from Albemarle) pre-activated with N,N-dimethylanilinium tetrakis (pentafluorophenyl) borate (obtained from Albemarle) at a molar ratio of about 1:1 in toluene. The catalyst solution was kept in an inert atmosphere with <1.5 ppm water content and was fed into reactor by a metering pump through a separated line. Catalyst and monomer contacts took place in the reactor.

As an impurity scavenger, 250 ml of tri-n-octyl aluminum (TNOA) (25 wt % in hexane, Sigma Aldrich) was diluted in 22.83 kilogram of hexane. The TNOA solution was stored in a 37.9-liter cylinder under nitrogen blanket. The solution was used for all polymerization runs until about 90% of consumption, then a new batch was prepared. The feed rates of the TNOA solution were adjusted in a range from 0 (no scavenger) to 4 ml per minute to achieve a maximum catalyst activity.

The reactor was first cleaned by continuously pumping solvent (e.g., hexane) and scavenger through the reactor system for at least one hour at a maximum allowed temperature (about 150° C.). After cleaning, the reactor was heated/cooled to the desired temperature using a water/steam mixture flowing through the reactor jacket and controlled at a set pressure with controlled solvent flow. Monomers and catalyst solutions were then fed into the reactor when a steady state of operation was reached. An automatic temperature control system was used to control and maintain the reactor at a set temperature. Onset of polymerization activity was determined by observations of a viscous product and lower temperature of water-steam mixture. Once the activity was established and the system reached equilibrium, the reactor was lined out by continuing operation of the system under the established condition for a time period of at least five times of mean residence time prior to sample collection. The resulting mixture, containing mostly solvent, polymer and unreacted monomers, was collected in a collection box after the system reached a steady state operation. The collected samples were first air-dried in a hood to evaporate most of the solvent, and then dried in a vacuum oven at a temperature of about 90° C. for about 12 hours. The vacuum oven dried samples were weighed to obtain yields. All the reactions were carried out at a pressure of about 2.41 MPa-g. The detailed polymerization condition and some product properties are listed in Table 1A and the C-13 NMR data for polymer products are listed in Table 1B.

TABLE 1A

Run No.

| | 1-1 | 1-2 |
|---|---|---|
| Polymerization temperature (° C.) | 100 | 100 |
| Propylene feed rate (g/min) | 14 | 14 |
| Hexene-1 feed rate (ml/min) | 1.5 | 1.8 |
| Catalyst feed rate (mol/min) | 9.45E−07 | 9.45E−07 |
| Hexane flow rate (ml/min) | 80 | 80 |
| Tm (° C.) | 101 | 104 |
| Tc (° C.) | 52 | 62 |
| Tg (° C.) | | −13 |
| Heat of fusion (J/g) | 49 | 55.11 |
| Mn (kg/mol) | 5 | |
| Mw (kg/mol) | 30.53 | |
| Mz (kg/mol) | 63.129 | |
| MWD | 5.92 | |
| Viscosity @190° C. (mPa · sec) | | 628 |
| Tensile strength (MPa) | | 14.6 |
| Elongation at break (%) | | 295 |
| Modulus (MPa) | | 195.2 |
| Toughness (megajoule/m³) | | 34.8 |
| Copolymer hexene content (wt %) | 8.1 | 8.1 |

TABLE 1B
C-13 NMR Data for polymers produced in Example 1

Run No.

| | |
|---|---|
| 1-1 | 1-2 |

| | |
|---|---|
| Triad | Mole Fraction |

| | | |
|---|---|---|
| [HHH] | 0.002 | 0.002 |
| [HHP] | 0.006 | 0.006 |
| [PHP] | 0.034 | 0.034 |
| [HPH] | 0.000 | 0.000 |
| [HPP] | 0.101 | 0.101 |
| [PPP] | 0.857 | 0.857 |

Regios per 10,000 Units

| | | |
|---|---|---|
| 2,1 erythro | 8 | 9 |
| 2,1 threo | 0 | 0 |
| 1,3 insertions | 28 | 23 |

End Groups per 10,000 Units

| | | |
|---|---|---|
| Butyl | 3 | 4 |
| Propyl | 29 | 28 |
| Isobutyl | 43 | 33 |
| Vinylidene | 0 | 28 |
| Trisub. | 9 | 13 |

Hexene Composition

| | | |
|---|---|---|
| Wt (%) | 8.1 | 8.1 |

A number of coating compositions were prepared by blending the polymers produced in Runs 1-1 and 1-2 with one or more of functionalized additives, tackifier, wax, antioxidant, and other ingredients under low shear mixing at elevated temperatures to form fluid melts. The mixing temperature varied from about 130° C. to about 190° C. As examples, Tables 1C and 1D below list the detailed formulation and the properties of the resulting blends. In Tables 1C and 1D, MAPP40 is a maleic anhydride modified polypropylene, having an acid number of 50, a viscosity of 300 mPa sec. at 190° C., a softening point of 149° C., available from Chusei, USA., and MA-POA is a functionalized propylene based coating composition produced according to the procedure described in WO2005105868. The prefunctionalized polymer has Mn/Mw/Mz of 20.7/40.6/72.5 kg/mole, a heat of fusion of 29.5 J/g, and a melting peak temperature of 132° C. The maleated polymer contains 1.41 wt % of maleic anhydride. Sasol C80 wax is a Fischer-Tropsch wax obtained from Moore and Munger. and Escomer H101 is functionalized wax supplied by ExxonMobil Chemicals, Houston, Tex. All the adhesion tests were conducted at ambient condition unless otherwise noted. The formulations are listed in weight percent unless otherwise noted. The fiber tear was tested on Inland paper board unless otherwise noted. These Examples demonstrate that coatings with good adhesion at room temperature and −18° C. could be achieved using a formulation comprising the present propylene polymer with very low viscosity and small quantities (<20 wt %) of additives.

TABLE 1C
Adhesive performance obtained using Dot T-Peel test on Inland board

| | Coating formulation No. | | | |
|---|---|---|---|---|
| | 1-1 | 1-2 | 1-3 | 1-4 |
| Run No. 1-1 polymer (wt %) | 85 | 85 | 85 | 85 |
| MAPP40 (wt %) | 10 | 10 | 0 | 0 |
| MA-POA (wt %) | 0 | 0 | 10 | 10 |
| C80 wax (wt %) | 5 | 0 | 5 | 0 |
| Escomer H101 (wt %) | 0 | 5 | 0 | 5 |
| Viscosity at 160° C. (mPa sec) | 1200 | 1200 | 1200 | 1200 |
| Set time (sec) | 1.5 | 1.5 | 1 | 2 |
| Viscosity at 190° C. (mPa · sec) | 507 | 515 | 550 | 496 |
| Fiber tear at room temperature (%) | >90 | >90 | >90 | <70 |
| Fiber tear at −2° C. (%) | >90 | >90 | >90 | <70 |
| Fiber tear at −18° C. (%) | >90 | <70 | >90 | <70 |

TABLE 1D
Adhesive performance obtained using Dot T-Peel on Inland board

| | Coating formulation No. | | | | | |
|---|---|---|---|---|---|---|
| | 1-5 | 1-6 | 1-7 | 1-8 | 1-9 | 1-10 |
| Run No. 1-2 Polymer | 90 | 90 | 89 | 88 | 85 | 85 |
| (wt %) | | | | | | |
| MAPP40 (wt %) | 0 | 0 | 0 | 0 | 10 | 0 |
| MA-POA (wt %) | 5 | 4 | 5 | 5 | 0 | 10 |
| C80 wax (wt %) | 5 | 6 | 6 | 7 | 5 | 5 |
| Set time (sec.) | 2.5 | 2.5 | 3 | 2 | 2.5 | 2 |
| Viscosity at 160° C. | na | na | na | na | 1090 | 1250 |
| (mPa sec) | | | | | | |
| Viscosity at 190° C. | 650 | 605 | 680 | 571 | na | na |
| (mPa sec) | | | | | | |
| Fiber tear at room | 85 | 10 | 40 | 0 | 94 | 95 |
| temperature (%) | | | | | | |
| Fiber tear at −2° C. (%) | 88 | 10 | 0 | 0 | 95 | 95 |
| Fiber tear at −18° C. (%) | 65 | 5 | 5 | 0 | 90 | 95 |

### Example 2

Propylene polymers in Example 2 were produced following the same procedure as described in Example 1. Detailed conditions and some properties data are listed in Table 2A. Runs #2-1 and 2-12 are comparative examples. They were produced under similar conditions as the other runs in Example 2 except that there was no 1-hexene fed into the reactor for these two runs. Polymer produced in Run #2-1 was too brittle for tensile testing. The specimen broke in the grip. Tensile testing for polymer produced in Run #2-2 and Run #2-3 were conducted on a Type V specimen defined in ASTM D 638-03 (0.25 inch wide and 0.146 inch thick). Tensile testing for polymer produced in Run #2-11 and 2-12 were conducted on a Type I specimen defined in ASTM D 638-03 (0.5 inch wide and 0.0745 inch thick). Significant improvements in mechanical properties such as elongation and toughness for propylene copolymers with 1-hexene as compared with polypropylene homopolymer at similar viscosity are revealed in this table. This is especially true for polymers with low viscosity (<800 mPa. sec). Good mechanical properties at this low viscosity copolymer allow coatings with less additives to be made without sacrificing their cohesive strength.

The copolymers with higher viscosity are good for coating applications where strong mechanical strength is required.

TABLE 2A

| Run # | 2-1 | 2-2 | 2-3 | 2-4 | 4-5 | 2-6 |
|---|---|---|---|---|---|---|
| Polymerization temperature (° C.) | 100 | 100 | 100 | 100 | 100 | 100 |
| Propylene feed rate (g/min) | 14 | 14 | 14 | 14 | 14 | 14 |
| Hexene-1 feed rate (ml/min) | 0 | 1 | 2 | 3 | 4 | 5 |
| Hexane (ml/min) | 80 | 80 | 80 | 80 | 80 | 80 |
| Catalyst feed rate (mol/min) | 1.18E−06 | 1.18E−06 | 1.2E−06 | 1.18E−06 | 1.2E−06 | 1.2E−06 |
| Yield (g/min.) | 14.1 | 14.6 | 15.1 | 15.9 | 16.4 | 17.5 |
| Copolymer hexene content (wt %) | 0 | 3.92 | | 11.3 | | 18.7 |
| Tm (° C.) | 134.2 | 120.4 | 106.9 | 95.9 | 84.3 | 73.9 |
| Tc (° C.) | 95.0 | 75.6 | 51.3 | 38.2 | 16.1 | 3.9 |
| Tg (° C.) | | | −10.7 | −11.4 | −14.3 | −21.3 |
| Heat of fusion (J/g) | 78.0 | 68.8 | 54.2 | 49.1 | 33.5 | 28.6 |
| Viscosity @190° C. (mPa sec) | 580.0 | 565.0 | 775.0 | 625.0 | 685.0 | 732.5 |
| Elongation at break (%) | | 1.9 | 5.57 | 747.8 | 723.7 | 958.9 |
| Tensile strength (MPa) | | 0.41 | 0.744 | 10.2 | 14.8 | 14.7 |
| Toughness (megajoule/m³) | | 1.41 | 7.41 | 435.7 | 817.9 | 952.5 |

| Run # | 2-7 | 2-8 | 2-9 | 2-10 | 2-11 | 2-12 |
|---|---|---|---|---|---|---|
| Polymerization temperature (° C.) | 80 | 80 | 80 | 80 | 80 | 80 |
| Propylene feed rate (g/min) | 14 | 14 | 14 | 14 | 14 | 14 |
| Hexene-1 feed rate (ml/min) | 5 | 4 | 3 | 2 | 1 | 0 |
| Hexane (ml/min) | 80 | 80 | 80 | 80 | 80 | 80 |
| Catalyst feed rate (mol/min) | 9.4E−07 | 9.4E−07 | 9.4E−07 | 9.4E−07 | 9.4E−07 | 9.4E−07 |
| Yield (g/min.) | 18.2 | 17.6 | 16.0 | 15.5 | 14.8 | 14.3 |
| Copolymer hexene content (wt %) | 17.9 | | 12.4 | | 3.7 | 0 |
| Tm (° C.) | 79.0 | 85.6 | 99.0 | 113.2 | 129.2 | 146.8 |
| Tc (° C.) | 13.9 | 20.8 | 44.1 | 65.5 | 85.1 | 105.4 |
| Tg (° C.) | −17.1 | −19.7 | −14.3 | −7.3 | −4.5 | — |
| Heat of fusion (J/g) | 30.8 | 35.8 | 50.5 | 56.3 | 73.8 | 90.1 |
| Viscosity @190° C. (mPa sec) | 22400.0 | 15220.0 | 14300.0 | 10560.0 | 8850.0 | 6000.0 |
| Elongation at break (%) | 1452.4 | 1232.2 | 1053.8 | 1003.6 | 6.07 | 1.93 |
| Tensile strength (MPa) | 30.0 | 28.2 | 29.1 | 27.8 | 20.93 | 6.73 |
| Toughness (megajoule/m³) | 1520.1 | 1817.4 | 1525.6 | 1664.2 | 485.5 | 12.78 |

A number of coating compositions were prepared by blending the polymer produced in Example 2 with one or more of functionalized additives, wax, antioxidant, and other ingredients under low shear mixing at elevated temperatures to form fluid melt. The mixing temperature varied from about 130° C. to about 190° C. As examples, Tables 2B and 2C below list the detailed formulation and the properties of blends. All the adhesion tests were conducted at ambient condition unless otherwise noted. The formulations are listed in weight percent unlike otherwise noted. The fiber tear was tested on Inland paper board. All of these coatings were produced using 8 wt % of other ingredients. Coating formulations 2-1 and 2-2 are comparative examples and were produced using homopolypropylene as base polymers. The adhesive properties for propylene copolymers were significantly improved as compared with those for the propylene homopolymer. Also good adhesion was obtained by using copolymers having high 1-hexene content, but the set time was longer. The desired balance of adhesive properties and mechanical strength for the present coatings can be achieved by varying the 1-hexene content, polymer viscosity (or molecular weight), crystallinity, as well as by the addition of other ingredients.

TABLE 2B

| Coating formulation No. | 2-1 | 2-2 | 2-3 | 2-4 | 2-5 | 2-6 |
|---|---|---|---|---|---|---|
| Polymer produced in | run no 2-1 | run no 2-1 | run no 2-2 | run no 2-2 | run no 2-3 | run no 2-3 |
| Example 2 | | | | | | |
| Polymer (wt %) | 92 | 100 | 92 | 100 | 92 | 100 |
| C80 wax (wt %) | 5 | 0 | 5 | 0 | 5 | 0 |
| MAPP 40 (wt %) | 2 | 0 | 2 | 0 | 2 | 0 |
| Irganox 1010 (wt %) | 1 | 0 | 1 | 0 | 1 | 0 |
| Set time (second) | 2.75 | 3.5 | 2.5 | 5.5 | 2.5 | >6 |
| Fiber tear at room | 0 | 0 | 69 | 0 | 98 | 0 |
| temperature (%) | | | | | | |
| Fiber tear at 2° C. (%) | 0 | 0 | 89 | 0 | 89 | 0 |
| Fiber tear at −18° C. (%) | 0 | 0 | 73 | 0 | 70 | 0 |
| Hardness (Shore A) | 98 | 98 | 98 | 99 | 99 | 98 |

TABLE 2C

| Coating formulation No. | 2-7 | 2-8 | 2-9 | 2-10 | 2-11 | 2-12 |
|---|---|---|---|---|---|---|
| Polymer produced in | run no 2-4 | run no 2-4 | run no 2-5 | run no 2-5 | run no 2-6 | run no 2-6 |
| Example 2 | | | | | | |
| Polymer (wt %) | 92 | 100 | 92 | 100 | 92 | 100 |
| C80 wax (wt %) | 5 | 0 | 5 | 0 | 5 | 0 |
| MAPP 40 (wt %) | 2 | 0 | 2 | 0 | 2 | 0 |
| Irganox 1010 (wt %) | 1 | 0 | 1 | 0 | 1 | 0 |
| Set time (second) | 3 | >6 | 4 | >6 | 5 | >6 |
| Fiber tear at room | 100 | 0 | 100 | 38 | 98 | 0 |
| temperature (%) | | | | | | |
| Fiber tear at 2° C. (%) | 97 | 0 | 97 | 5 | 99 | 75 |
| Fiber tear at −18° C. (%) | 92 | 0 | 28 | 0 | 99 | 40 |
| Hardness (Shore A) | 98 | 97 | 94 | 95 | 87 | 83 |

Certain embodiments and features have been described using a set of numerical upper limits and a set of numerical lower limits. It should be appreciated that ranges from any lower limit to any upper limit are contemplated unless otherwise indicated. Certain lower limits, upper limits and ranges appear in one or more claims below. All numerical values are “about” or “approximately” the indicated value, and take into account experimental error and variations that would be expected by a person having ordinary skill in the art.

Various terms have been defined above. To the extent a term used in a claim is not defined above, it should be given the broadest definition persons in the pertinent art have given that term as reflected in at least one printed publication or issued patent. Furthermore, all patents, test procedures, and other documents cited in this application are fully incorporated by reference to the extent such disclosure is not inconsistent with this application and for all jurisdictions in which such incorporation is permitted.

While the foregoing is directed to embodiments of the present invention, other and further embodiments of the invention may be devised without departing from the basic scope thereof, and the scope thereof is determined by the claims that follow.

What is claimed is:

1. A method for forming a coated article, comprising:
melting a composition comprising at least one polymer comprising 50 wt % propylene derived units, the polymer having:
a weight average molecular weight (Mw) of about 10,000 to about 100,000;
a percent crystallinity of about 5% to about 40%;
a melt index of about 30 dg/min or more; and
a melting point of about 40° C. to about 150° C.,
applying the melted composition to at least a portion of the article to be coated to form a coating having a first side adhering to the article and a second side substantially free of an additional substrate in which to adhere; and
cooling the article to form a coated article.

2. The method of claim 1, wherein the second side of the coating is free of an additional substrate.

3. The method of claim 1, wherein the polymer comprises of from about 2 wt % to about 30 wt % of at least one olefin selected from ethylene and C₄ to C₁₀ olefins.

4. The method of claim 1, wherein the polymer comprises of from about 2 wt % to about 30 wt % of at least one C₆ to C₁₀ olefin.

5. The method of claim 1, wherein the polymer comprises of from about 2 wt % to about 30 wt % hexene.

6. The method of claim 1, wherein the polymer has a melt index of 50 dg/min or more.

7. The method of claim 1, wherein the polymer has a melting point of from about 60° C. to about 140° C.

8. The method of claim 1, wherein the polymer has a melting point of from about 60° C. to about 110° C.

9. The method of claim 1, wherein the composition further comprises from 0.1 wt % to 20 wt %, based on total weight of the composition, of wax or functionalized polyolefin or both.

10. The method of claim 1, wherein the composition further comprises from 0.1 wt % to 10 wt %, based on total weight of the composition of maleated polypropylene.

11. The method of claim 1, wherein the polymer has a ratio (MWD) of weight averaged molecular weight (Mw) to number averaged molecular weight (Mn) of about 2.0 to about 5.0.

12. The method of claim 1, wherein the polymer has a branching index (g′) of 0.95 or less measured at the Mz of the polymer when the polymer has a Mw of 10,000 to 100,000.

13. The method of claim 1, wherein the polymer has a viscosity of from 500 mPa to about 35,000 mPa measured at 190° C. using a Brookfield viscometer.

14. The method of claim 1, wherein the composition further comprises one or more additives, tackifiers, block copolymers, or a combination thereof.

15. The method of claim 1, wherein the composition further comprises about 1 wt % to about 80 wt %, based on total weight of the composition, of tackifier.

16. The method of claim 1, wherein the composition further comprises one or more block copolymers.

17. The method of claim 1, wherein the composition further comprises from 0.1 wt % to 30 wt %, based on total weight of the composition, of SIS, SBS, SEBS, SEPS, polyurethane, or a combination thereof.

18. The method of claim 1, wherein the coating composition is used to enhance the grip of the article.

19. The method of claim 1, wherein the coating composition is applied to thermoplastic resin articles having a softening point that is greater than the melting point of the propylene polymer.

20. The method of claim 1, wherein the coating composition does not comprise a hydrocarbon solvent or conventional plasticizer.

21. The method of claim 1, wherein the coating composition has a viscosity of 500 to 35,000 mPa-sec when measured at 190° C. using a Brookfield viscometer.

22. The method of claim 1, wherein the article is a handle and the coating composition is used to enhance the grip of the handle.

23. The method of claim 1, wherein the article is a handle and wherein the handle is harder than the coating composition.

24. A method for forming a coated article, comprising:
melting a composition comprising at least one polymer comprising 50 wt % propylene derived units and about 5 wt % to about 15 wt % of at least one C₄-C₁₀ olefin, the polymer having:
a weight average molecular weight (Mw) of about 10,000 to about 100,000;
a ratio (MWD) of weight averaged molecular weight (Mw) to number averaged molecular weight (Mn) of about 1.8 to about 9.0;
a percent crystallinity of about 5% to about 40%;
a melt index of more than 50 dg/min; and
a melting point of about 40° C. to about 150° C.,
applying the melted composition to at least a portion of the article to be coated to form a coating having a first side adhering to the article and a second side substantially free of an additional substrate in which to adhere; and
cooling the article to form a coated article.

25. A method for forming a coated article, comprising:
melting a composition wherein the composition comprises:
(a) at least 50 wt %, based on total weight of the composition, of at least one polymer wherein the polymer has:
(i) a weight average molecular weight (Mw) of about 10,000 to about 100,000;
(ii) a ratio (MWD) of weight averaged molecular weight (Mw) to number averaged molecular weight (Mn) of about 1.8 to about 9.0;
(iii) a percent crystallinity of about 5% to about 40%;
(iv) a melt index of greater than about 50 dg/min;
(v) a melting point of about 80° C. to about 140° C.;
(vi) 50 wt % propylene derived units; and
(vii) hexene from about 5 wt % to about 15 wt %;
(b) tackifier from about 1 wt % to about 80 wt %, based on total weight of the composition;
(c) functionalized polyolefin from 0.1 wt % to 20 wt %, based on total weight of the composition, and
(d) wax from 0.1 wt % to 20 wt %, based on total weight of the composition;
applying the melted composition to at least a portion of the article to be coated to form a coating having a first side adhering to the article and a second side substantially free of an additional substrate in which to adhere; and
cooling the article to form a coated article.
